(19) United States
(12) Patent Application Publication
(10) Pub. No.: US 2005/0015420 A1
(43) Pub. Date: Jan. 20, 2005

(54) Recoded radix-2 pipeline FFT processor

(76) Inventors: Sean G. Gibb, Calgary (CA); Peter J.W. Graumann, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/760,379

(22) Filed: Jan. 21, 2004

Related U.S. Application Data
(60) Provisional application No. 60/487,975, filed on Jul. 18, 2003.

(51) Int. Cl. G06F 15/00

(52) U.S. Cl. 708/404

(57) ABSTRACT

A single-path delay feedback pipelined fast Fourier transform processor comprising at least one set of triplet FFT stage means: a first FFT stage means comprising a radix-2 butterfly, a feedback memory, and a multiplication by unity; a second FFT stage means comprising a trivial coefficient pre-multiplication, a radix-2 butterfly, a feedback memory, and a multiplication by selectable unity or W_{N}^{N/8}; and a third FFT stage means comprising a trivial coefficient pre-multiplication, a butterfly, a feedback memory, and a complex twiddle coefficient multiplication with coefficients determined using a twiddle factor decomposition technique.

### CROSS-REFERENCE TO RELATED APPLICATIONS

This application claims the benefit of U.S. Provisional Patent Application No. 60/487,975, filed Jul. 18, 2003, which is incorporated herein by reference in its entirety.

### FIELD OF THE INVENTION

The present invention relates generally to pipelined FFT processors. More particularly, the present invention relates to a single path delay feedback pipelined fast Fourier transform processor.

### BACKGROUND OF THE INVENTION

Fourier transforms are well understood mathematical operations used to obtain a frequency varying representation of a time varying signal. The inverse Fourier transform performs the opposite operation. Though the Fourier transform is a useful analytical tool for continuous functions, it cannot transform a discrete function, nor can it transform a sequence of samples, which is a more common occurrence in most applications. The discrete Fourier transform (DFT) fulfils this purpose.

The DFT is an important functional element in many digital signal-processing systems, including those that perform spectral analysis or correlation analysis. The purpose of the DFT is to compute the sequence of {X(k)} of N complex-valued numbers given another sequence of data {x(n)}of length N, as expressed by the formula

$$X ( k ) = {\sum }_{n = 0}^{N - 1} x ( n ) {W}_{N}^{kn} where {W}_{N} = {ⅇ}^{- j 2 π / N}$$

It can be observed from these formulas that for each value of k, a direct computation of X(k) involves N complex multiplications and N−1 complex additions. Thus, to compute all N values of the DFT would require N² complex multiplications and N²−N complex additions. This general form solution can be decomposed using a divide-and-conquer based approach, to reduce the computational complexity associated with the DFT. Using the divide and conquer approach splits the data sequence into parts and processes each part separately. Each separate part can be further divided. This decomposition forms the basic fast Fourier transform (FFT) operation, where the most commonly used decimating factors are 2 or 4 (leading to the radix-2 or radix-4 FFT implementations of the DFT). In a divide-and-conquer approach the computation of the DFT is decomposed into nested DFTs of progressively shorter length until the DFT has been reduced to its radix. Twiddle factors, which effectively perform a phase rotation in the complex plane, are generated as the divide-and-conquer algorithm proceeds. For a radix-2 decomposition, a length-2 DFT is performed on the input data sequence {x(n)}. The results of the first stage of length-2 DFTs are combined using a length-2 DFT and then the resulting value is rotated in the complex plane by multiplication of the resulting value by the appropriate twiddle factors. This process continues until all N values have been processed and the final output sequence {X(k)} is generated. The decomposition of the input sequence into a series of smaller sequences can reduce the complexity associated from completing a DFT from a complexity of order N² to order N log₂N.

Many previous solutions have improved the throughput of an FFT processor while balancing the FFT latency against the area requirements of the FFT processor by using pipeline processor based architecture. In a pipeline processor architecture the primary concern is increasing throughput and decreasing latency while attempting to also minimize the area requirements of the processor architecture. A common pipeline FFT architecture achieves this by implementing a single length-2 DFT (using a radix-2 butterfly operation performed in a butterfly unit) for each stage in the DFT recombination calculation. It is also possible to implement less than or more than one butterfly unit per recombination stage, however, in a real-time digital system it is sufficient to match the computing speed of the FFT processor with the input data rate. If the data acquisition speed is one sample per cycle then it is sufficient to have a single butterfly unit per recombination stage.

A brief review of previous pipeline FFT architectures is herein provided in order to place the FFT processor in accordance with the invention into perspective. In this discussion, algorithms implementing the radix-2, radix-4, and more complex systems will be covered. Input and output order will be assumed to be in whatever form is most appropriate for the algorithm. If a different order is required then the appropriate reordering buffer can be provided at the input or output of the pipeline FFT for the cost of the memory associated with implementing the buffer. Systems that provide in-order input are most suitable for systems where data is arriving one sample at a time and can be processed immediately. Out-of-order input is most appropriate in buffered data where the data can be pulled from the buffer in any order. All of the architectures presented are based on the Decimation-In-Frequency (DIF) decomposition of the DFT. Input and output data is complex and all arithmetic operations are also complex. For the radix-2 algorithms a constraint that N is a power-of-2 applies. The radix-4 algorithm constrains N to powers-of-4 and the radix-8 algorithm (R2³SDF) constrains N to powers-of-8. For clarity, all of the control and twiddle factor hardware requirements have been omitted.

FIG. 1 illustrates the general implementation of a prior art 16-point Radix-2 Multi-path Delay Commutator (R2MDC) pipeline FFT. In general, the R2MDC approach breaks the input sequence into two parallel data streams. At each stage one half of the data stream is buffered in memory and is then processed in parallel with the second half of the data stream. The multipliers and adders in the R2MDC architecture are 50% utilized. The R2MDC architecture requires 3/2N−2 delay registers.

FIG. 2 illustrates the general implementation of a prior art 256-point Radix-4 Multi-path Delay Commutator (R4MDC). In general, the R4MDC is a radix-4 version of the R2MDC, which breaks the input sequence into four parallel data streams. The R4MDC architecture utilizes all components only 25% of the time. It requires 5/2N−4 delay registers

FIG. 3 illustrates the general implementation of a prior art Radix-2 Single-path Delay Feedback (R2SDF) pipeline 16-bit FFT. In general, the R2SDF approach uses the registers more efficiently than the R2MDC implementation by storing the butterfly unit output in feedback shift registers. The R2SDF implementation achieves 50% utilization of multipliers and adders and requires N−1 delay registers.

FIG. 4 illustrates the general implementation of a prior art 256-point Radix-4 Single-path Delay Feedback (R4SDF) pipeline FFT. In general, the R4SDF is a radix-4 version of the R2SDF. The utilization of the multipliers increases to 75% in the implementation, however the adders are only 25% utilized. As in the R2SDF architecture, the R4SDF architecture requires N−1 delay registers. The memory storage is fully utilized as in the R2SDF case.

FIG. 5 illustrates the general implementation of a prior art 256-point Radix-4 Single-path Delay Commutator (R4SDC) pipeline FFT. In general, the R4SDC uses a modified radix-4 algorithm to achieve 75% utilization of the multipliers. The memory requirement of the R4SDC implementation is 2N−2.

FIG. 6 illustrates the general implementation of a prior art 256-point Radix-2² Single-path Delay Feedback (R2²SDF) pipeline FFT architecture. In general, the R2²SDF architecture breaks one radix-4 butterfly operation into two radix-2 butterfly operations with trivial multiplications of ±1 and ±j in order to achieve 75% multiplier utilization and 50% adder utilization. The memory requirement of the R2²SDF architecture is N−1.

FIG. 7 illustrates the general implementation of a prior art 512-point Radix-2³ Single-path Delay Feedback (R2³SDF) pipeline FFT architecture. The R2³SDF architecture minimizes the hardware requirements of a radix-8 butterfly unit by utilizing a technique similar to the R2²SDF architecture. A single radix-8 butterfly unit is implemented as a combination of three radix-2 butterfly units with inter-butterfly delay hardware and trivial multiplications of ±1, ±j, and 0.707(±1−j). The memory requirements of the R2³SDF architecture are N−1.

In view of the above described prior art, it is apparent that it would be desirable for an FFT processor to be provided that reduces the complexity of the hardware required for implementation. It would be desirable to additionally provide an FFT processor that can be implemented in a reduced semiconductor area. It would be desirable to produce an FFT that can obtain this reduced hardware complexity and semiconductor area for any power-of-2 length FFT operation.

### SUMMARY OF THE INVENTION

It is an object of the present invention to obviate or mitigate at least one disadvantage of previous pipelined FFT processors.

In a first aspect of the present invention there is provided a pipelined fast Fourier transform (FFT) processor for receiving an input sequence. The processor comprises at least one FFT triplet for receiving the input sequence and for outputting a final output sequence representing an FFT of the input sequence. The at least one FFT triplet has first, second and third butterfly modules that are connected in series by selectable multipliers. The selectable multipliers selectively perform trivial co-efficient multiplication and complex co-efficient multiplication on output sequences of adjacent butterfly modules. Each of the at least one FFT triplets terminates in a twiddle factor multiplier. The multiplier applies a twiddle factor to an output of the third butterfly module of its respective triplet.

In an embodiment of the first aspect of the present invention, each butterfly module includes a radix-2 butterfly unit and a feedback memory, where preferably for an input sequence of N samples, an output sequence X(k, n) of each butterfly module is equal to

$$x ( n ) + {( - 1 )}^{k} x ( n + \frac{N}{2} ) .$$

In another embodiment of the present invention at least one of the selectable multipliers is integrated in an adjacent butterfly module. In another embodiment the selectable multipliers each include a multiplier and a switch for bypassing the multiplier. In a further embodiment, the first and second butterfly modules are connected by a selectable multiplier for selectively applying trivial co-efficient multiplication and the second and third butterfly modules are preferably connected by a selectable multiplier for performing trivial co-efficient multiplication and a selectable multiplier for performing complex co-efficient multiplication. In a further embodiment for an input sequence having N samples, the feedback memories for the first, second and third butterfly modules hold N2, N/4 and N/8 samples, respectively. In another embodiment the processor is for receiving an input sequence of length N, where (log₂N)mod3=1, the processor has a plurality of FFT triplets in seriatim and further includes an FFT terminator having a butterfly unit and a corresponding memory sized to hold a single sample, the FFT terminator for receiving the output sequence from the final twiddle factor multiplier and for performing a butterfly operation on the received output sequence to render an FFT of the input sequence. In an alternate embodiment, the processor is for receiving an input sequence of length N, where (log₂N)mod3=2, the processor has a plurality of FFT triplets in seriatim and further includes an FFT terminator having first and second butterfly units each butterfly unit having a corresponding memory sized to hold two samples and a single sample respectively, the first butterfly unit is connected to the second butterfly unit by a selective multiplier for selectively multiplying the output of the first butterfly unit by −j, the FFT terminator receives the output sequence from the final twiddle factor multiplier and performs a pair of butterfly operations on the received output sequence to render an FFT of the input sequence. In a further embodiment twiddle factor multiplier is a cordic rotator.

In a second embodiment of the present invention there is provided a pipelined FFT processor for receiving an input sequence of N samples. The processor comprises at least one FFT triplet. The at least one FFT triplet has a first FFT stage, a second FFT stage and a third FFT stage. The first FFT stage has a first stage radix-2 butterfly unit for receiving the input sequence and for providing a first stage output sequence in accordance with a butterfly operation performed on the input sequence, the first stage radix-2 butterfly unit has a first feedback memory connected thereto. The second FFT stage has a selectable multiplier for selectively multiplying the first stage output sequence by a trivial co-efficient, and a second stage radix-2 butterfly unit for providing a second stage output sequence in accordance with the butterfly operation performed on the output of the selectable multiplier, the second stage radix-2 butterfly unit has a second feedback memory connected thereto. The third FFT stage has a multiply selectable multiplier for selectively multiplying the second stage output sequence by at least one of the trivial co-efficient, and a complex co-efficient, a third stage radix-2 butterfly unit for providing a butterfly output in accordance with the butterfly operation performed on the output of the multiply selectable multiplier, the third stage radix-2 butterfly unit has a third feedback memory connected thereto, and a multiplier for multiplying the butterfly output by a twiddle factor, to provide an output sequence corresponding to an FFT of the input sequence.

In an embodiment of the second aspect of the present invention, each of the first, second and third stage output sequences X(k,n) is equal to

$$x ( n ) + {( - 1 )}^{k} x ( n + \frac{N}{2} ) .$$

In another embodiment at least one of the butterfly units includes an integrated pre-multiplication function for applying a trivial co-efficient multiplication to a received input sequence. In a further embodiment the FFT processor includes an FFT terminator determined in accordance with the length N of the input sequence. In one embodiment, the FFT terminator includes a butterfly module having a memory sized to store a single sample, for receiving as a terminator input, the output of the third FFT stage multiplier and for performing a butterfly operation on the terminator input to render an FFT of the input sequence of N samples. In an alternate embodiment, the FFT terminator includes a first butterfly module having a memory sized to store a pair of samples, for receiving-as a terminator input, the output of the third stage multiplier and for performing a butterfly operation on the terminator input, and a second butterfly module connected to the first butterfly module of the terminator by a selectable multiplier, the selectable multiplier for selectively multiplying the output of the first butterfly module of the terminator by −j the second butterfly module having a memory sized to store a single sample and for performing a butterfly operation on the selectively multiplied output of the first butterfly module of the terminator to render an FFT of the output sequence.

In a third embodiment of the present invention, there is provided a method of performing an FFT on a sequence of N samples in an FFT processor having a butterfly module. The method comprises the steps of repeating the following steps of receiving and buffering, generating and selectively multliplying, for all integers 1≦x≦log₂N. The step of receiving and buffering includes receiving and buffering

$$\frac{N}{{2}^{x}}$$

samples at a time from a sequence having N samples. The step of generating includes generating a 2-point FFT using the n^{th} and

$${( n + \frac{N}{{2}^{x}} )}^{th}$$

samples. The step of selectively multiplying includes selectively multiplying the generated 2-point FFT sequence by a complex valued multiplicand. Following the repetition of the above steps the method includes the step of terminating the FFT using a termination sequence determined in accordance with a (log₂N)mod3 relationship.

In an embodiment of the third aspect of the present invention the complex valued multiplicand is selected from a list including

$$1 , - j , \frac{\sqrt{2}}{2} - j \frac{\sqrt{2}}{2} ,$$

and a complex twiddle factor determined by the twiddle factor decomposition. In embodiments where (log₂N)mod3=1, the step of terminating the FFT includes buffering a sample received from the final selective multiplication and performing a 2-point FFT using the buffered sample and the subsequent sample in the sequence to obtain the FFT of the sequence of N samples. In embodiments where (log₂N)mod3=2, the step of terminating the FFT includes buffering a pair of samples received from the final selective multiplication and performing pair-wise 2-point FFTs using the two buffered samples and the two subsequent samples in the sequence; selectively multiplying the result of the pair-wise 2-point FFT by −j; and buffering a sample received from the selective multiplication of the pair-wise 2-point FFT and performing a 2-point FFT using the buffered sample and the subsequent sample in the sequence to obtain the FFT of the sequence of N samples.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

The invention is described with reference to the following drawings wherein:

FIG. 1 is a block diagram of a prior art 16-point R2MDC FFT processor;

FIG. 2 is a block diagram of a prior art 256-point R4MDCX FFT processor;

FIG. 3 is a block diagram of a prior art 16-point R2DSF FFT processor;

FIG. 4 is a block diagram of a prior art 256-point R4SDF FFT processor;

FIG. 5 is a block diagram of a prior art 256-point R4SDC FFT processor;

FIG. 6 is a block diagram of a prior art 16-point R2²SDF FFT processor;

FIG. 7 is a block diagram of a prior art 512-point R2²SDF FFT processor;

FIG. 8 is a Recoded Radix-2 DIF FFT Flow Graph for N=16;

FIG. 9 is an alternate Recoded Radix-2 DIF FFT Flow Graph for N=16;

FIG. 10 is a block diagram of an exemplary embodiment of an RR2SDF Pipeline FFT for N=128 block diagram;

FIG. 11 shows an exemplary Butterfly unit structure for a RR2SDF FFT Architecture;

FIG. 12 shows an alternate Butterfly unit structure for a RR2SDF FFT Architecture with pre-multiplication by the trivial constant coefficient j;

FIG. 13 is a block diagram for an alternate RR2SDF Pipeline FFT for N=128.

FIG. 14 is a block diagram of an FFT triplet according to the present invention;

FIG. 15 is a block diagram of an FFT terminator for use when (log₂N)mod 3=1;

FIG. 16 is a block diagram of an FFT terminator for use when (log₂N)mod3=2; and

FIG. 17 is a flowchart illustrating an method of the present invention.

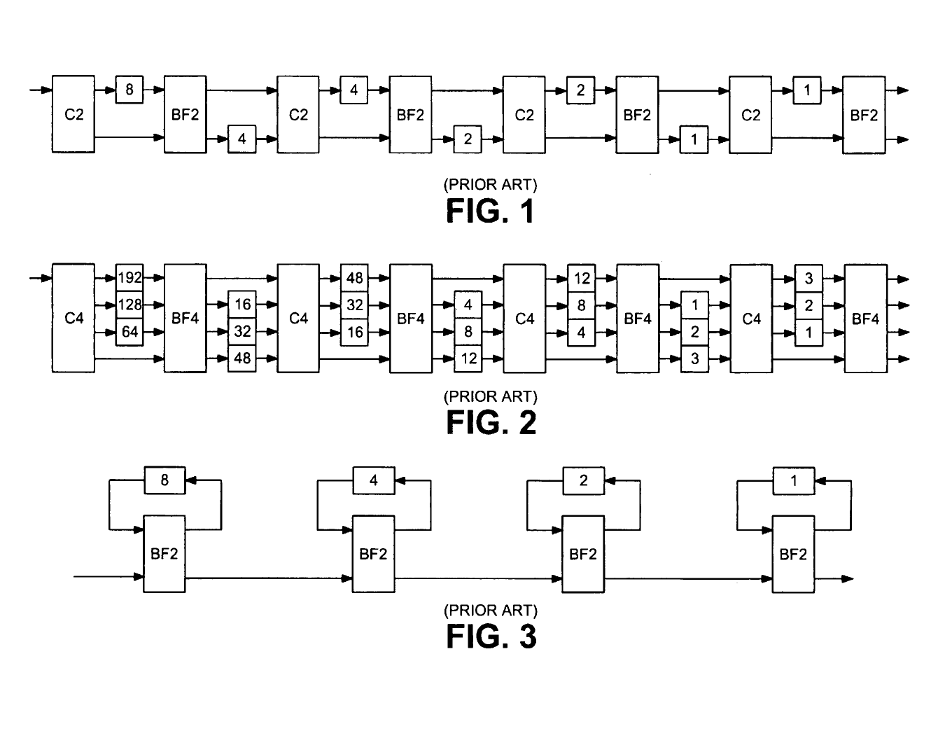

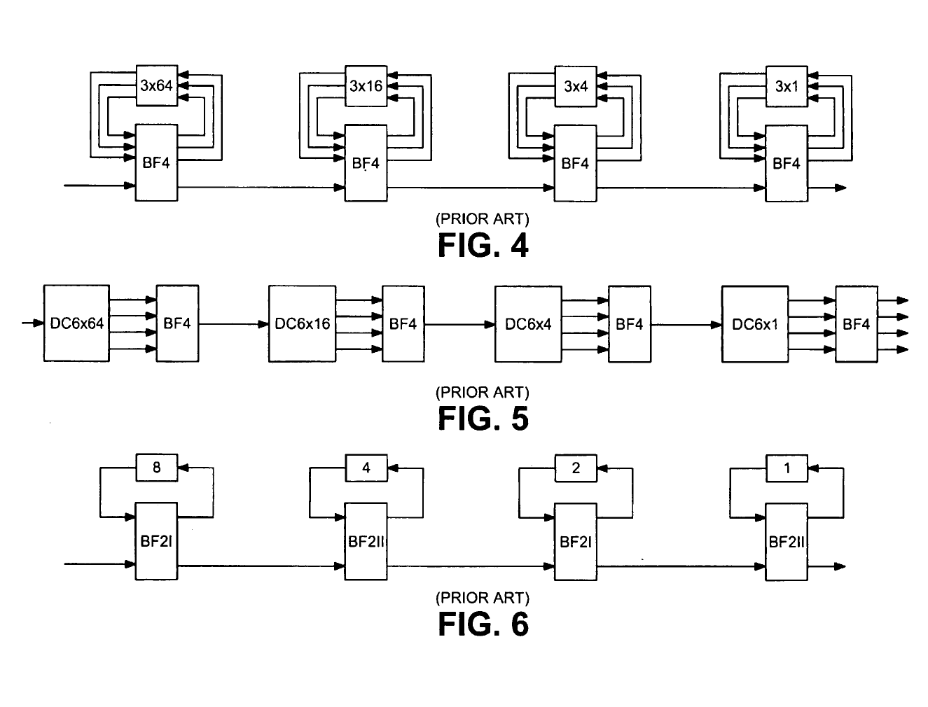

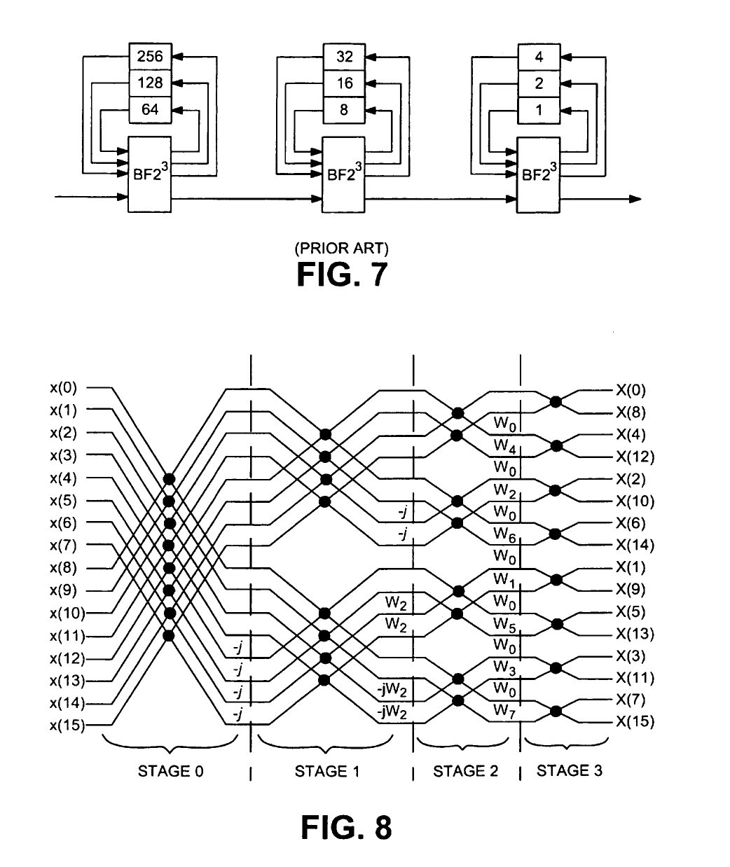

### DETAILED DESCRIPTION

The present invention provides a system and method for performing FFTs in a triplet manner. One embodiment of the present invention provides a triplet based FFT processor that allows for a physical implementation in a reduced semiconductor area due to a reduction in the hardware complexity in comparison to numerous systems of the prior art.

Embodiments of the present invention improve upon prior similar work by minimization of butterfly multiplicative complexity while maintaining a simple butterfly architecture. The multiplicative complexity of a radix-8 decomposition in a radix-2 decimation-in-frequency FFT processor is described. The multiplicative complexity of the butterfly can be any power-of-two radix but a practical limit is reached in the processor contemplated here due to the increased process control complexity overwhelming the hardware gains made using the techniques described.

The hardware gains made by embodiments of the present invention are accomplished in a single-path delay feedback pipelined fast Fourier transform processor, generally implemented in a VLSI chip, by recoding the FFT operation. A butterfly unit for generating an output mapping of

$$X ( k , n ) = x ( n ) + {( - 1 )}^{k} x ( x + \frac{N}{2} )$$

from an input sequence of x(n) having N samples is preferably implemented. This butterfly unit preferably employs appropriate simple adder and subtractor hardware with 2-to-1 multiplexers.

A butterfly module, having a butterfly unit and an appropriately sized feedback memory, is used in three FFT stages forming an FFT triplet. The FFT stages are, subject to process control and timing circuitry, in communication with other digital input from source signals, memory, or other FFT stages such that the overall data processing rate matches or exceeds the rate of the input sequence, also referred to as the digital input signal. This allows the FFT processor to perform successive transforms without pause.

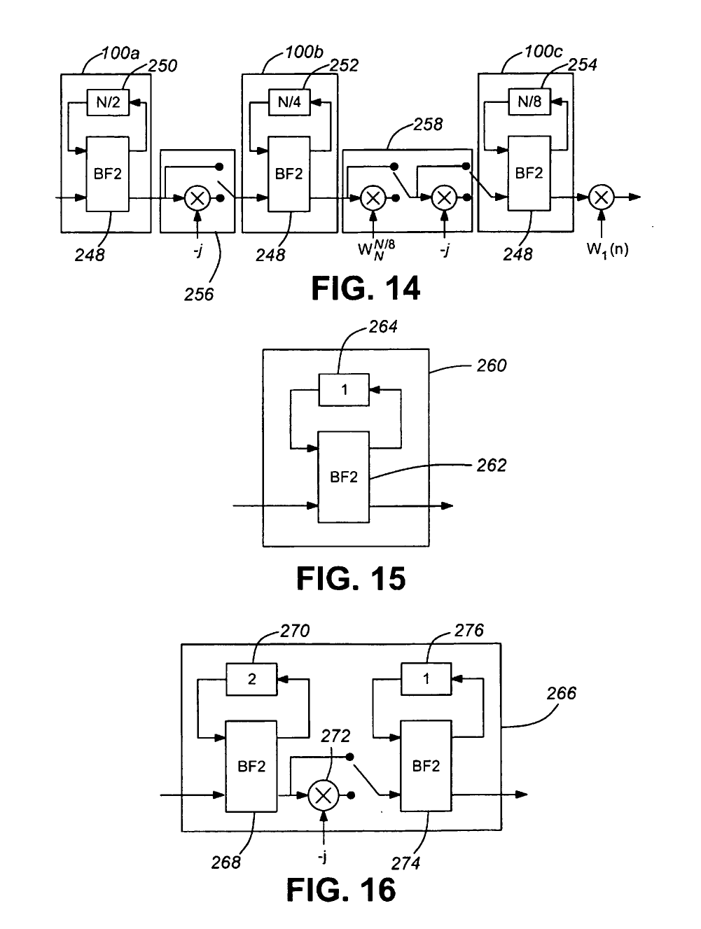

The cycle of the FFT processor of an embodiment of the present invention is such that its data processing rate preferably matches or exceeds the rate of the digital input signal and thus the FFT can operate on successive transforms without pause. The twiddle factor decomposition technique is used to determine the complex twiddle coefficients that may be terminated on any power-of-8 boundary such that the FFT operation can proceed using the standard radix-2 single-path delay feedback architecture such that the processor can thus perform any power-of-2 FFT by switching into a radix-2 multiplicative complexity FFT architecture in the final stages of the FFT. This can be achieved by terminating the twiddle factor decomposition one stage early in a power-of-4 length FFT and two stages early in a strictly power-of-2 length FFT. The use of the triplet of the present invention for any input sequence length that is a power of 2 is described in more detail below in conjunction with FIGS. 14, 15 and 16.

One motivation in the development of the method and system of the present invention was the reduction of the butterfly multiplier complexity while maintaining the simple butterfly architecture of the radix-2 algorithms. The coefficient-recoding method is based upon a twiddle factor decomposition technique. The recoded radix-2 method and system has the multiplicative complexity of the radix-8 decomposition while maintaining the structure and advantages of the radix-2 decomposition.

As described above, a DFT of size Nis defined by the equation

$$X ( k ) = {\sum }_{n = 0}^{N - 1} x ( n ) {W}_{N}^{kn} 0 \leq k < N \qquad ( 1 )$$

where W_{N} is the M^{th} twiddle factor and is defined by the equation
W_{N}=e^{-j2π/N}

The method of the present invention will be derived by considering the first three steps of the divide and conquer decomposition of the DFT equation together. After three decomposition steps the equations for n and k are defined by the following formulas

$$n = \frac{N}{2} {n}_{1} + \frac{N}{4} {n}_{2} + \frac{N}{8} {n}_{3} + {n}_{4} \\ k = {k}_{1} + 2 {k}_{2} + 4 {k}_{3} + 8 {k}_{4} \qquad ( 2 )$$

Applying the equations in (2) to the DFT equation (1) with three decomposition steps produces the following equation

$$X ( {k}_{1} + 2 {k}_{2} + 4 {k}_{3} + 8 {k}_{4} ) = {\sum }_{{n}_{4} = 0}^{\frac{N}{8} - 1} {\sum }_{{n}_{3} = 0}^{1} {\sum }_{{n}_{2} = 0}^{1} {\sum }_{{n}_{1} = 0}^{1} x ( \frac{N}{2} {n}_{1} + \frac{N}{4} {n}_{2} + \frac{N}{8} {n}_{3} + {n}_{4} ) {W}_{N}^{( \frac{N}{2} {n}_{1} + \frac{N}{4} {n}_{2} + \frac{N}{8} {n}_{3} + {n}_{4} ) ( {k}_{1} + 2 {k}_{2} + 4 {k}_{3} + 8 {k}_{4} )} \qquad ( 3 )$$

Expanding the innermost equation yields the equation

$$X ( {k}_{1} + 2 {k}_{2} + 4 {k}_{3} + 8 {k}_{4} ) = {\sum }_{{n}_{4} = 0}^{\frac{N}{8} - 1} {\sum }_{{n}_{3} = 0}^{1} {\sum }_{{n}_{2} = 0}^{1} \{ {B}_{\frac{N}{2}}^{{k}_{1}} ( \frac{N}{4} {n}_{2} + \frac{N}{8} {n}_{3} + {n}_{4} ) {W}_{N}^{( \frac{N}{4} {n}_{2} + \frac{N}{8} {n}_{3} - {n}_{4} ) {k}_{1}} \} {W}_{N}^{( \frac{N}{4} {n}_{2} + \frac{N}{8} {n}_{3} + {n}_{4} ) ( 2 {k}_{2} + 4 {k}_{3} + 8 {k}_{4} )} \qquad ( 4 )$$

where

$${B}_{\frac{N}{2}}^{{k}_{1}}$$

represents a butterfly operation and has the form

$${B}_{\frac{N}{2}}^{{k}_{1}} ( \frac{N}{4} {n}_{2} + \frac{N}{8} {n}_{3} + {n}_{4} ) = x ( \frac{N}{4} {n}_{2} + \frac{N}{8} {n}_{3} + {n}_{4} ) + {( - 1 )}^{{k}_{1}} x ( \frac{N}{4} {n}_{2} + \frac{N}{8} {n}_{3} + {n}_{4} + \frac{N}{2} ) \qquad ( 5 )$$

The expression in (4) can be further decomposed using a standard divide and conquer approach until a standard radix-2 decimation in frequency FFT is obtained. However, by reducing the twiddle coefficients using a second decomposition step, two butterfly architectures with a smaller circuit area can be obtained. By combining the two twiddle factor terms in equation (4) and minimizing the following equation is obtained

$$\begin{matrix}\begin{matrix}{W}_{N}^{( \frac{N}{4} {n}_{2} + \frac{N}{8} {n}_{3} + {n}_{4} ) ( {k}_{1} + 2 {k}_{2} + 4 {k}_{3} + 8 {k}_{4} )} = {W}_{N}^{2 {Nn}_{2} {k}_{4}} {W}_{N}^{N ( {n}_{2} {k}_{3} + {n}_{3} {k}_{4} )} {W}_{N}^{\frac{N}{2} ( {n}_{2} {k}_{2} + {n}_{3} {k}_{3} )} \\ {W}_{N}^{\frac{N}{4} ( {n}_{2} {k}_{1} + {n}_{3} {k}_{2} )} {W}_{N}^{\frac{N}{8} ( {n}_{3} {k}_{1} )} \\ {W}_{N}^{{n}_{4} ( {k}_{1} + 2 {k}_{2} + 4 {k}_{3} - 8 {k}_{4} )} \\ = {( - 1 )}^{( {n}_{2} {k}_{2} + {n}_{3} {k}_{3} )} {( - j )}^{( {n}_{2} {k}_{1} + {n}_{3} {k}_{2} )} {W}_{N}^{\frac{N}{1} ( {n}_{3} {k}_{1} )} \\ {W}_{N}^{{n}_{4} ( {k}_{1} + 2 {k}_{2} + 4 {k}_{3} )} {W}_{N}^{8 {n}_{4} {k}_{4}}\end{matrix} \\ where & ( 6 ) \\ {W}_{N}^{N / 8} = \frac{\sqrt{2}}{2} - j \frac{\sqrt{2}}{2} & ( 7 )\end{matrix}$$

Substituting equation (6) back into equation (4) and expanding the n₂ and n₃ summations yields

$$X ( {k}_{1} + 2 {k}_{2} + 4 {k}_{3} + 8 {k}_{4} ) = {\sum }_{{n}_{4} = 0}^{\frac{N}{8} - 1} [ Y ( {k}_{1} , {k}_{2} , {k}_{3} , {n}_{4} ) {W}_{N}^{{n}_{4} ( {k}_{1} + 2 {k}_{2} + 4 {k}_{3} )} ] {W}_{N / 8}^{{n}_{4} {k}_{4}} \qquad ( 8 )$$

where Y(k₁,k₂,k₃,n₄) can take either of the forms presented in equation (9) and equation (10).

$$Y ( {k}_{1} , {k}_{2} , {k}_{3} , {n}_{4} ) = \{ [ x ( {n}_{4} ) + {( - 1 )}^{{k}_{1}} x ( {n}_{4} + \frac{N}{2} ) ] + {( - 1 )}^{{k}_{2}} ( {( - j )}^{{k}_{1}} [ x ( {n}_{4} + \frac{N}{4} ) + {( - 1 )}^{{k}_{1}} x ( {n}_{4} + \frac{3 N}{4} ) ] ) \} + {( - 1 )}^{{k}_{3}} \{ ( [ x ( {n}_{4} + \frac{N}{8} ) + {( - 1 )}^{{k}_{1}} x ( {n}_{4} + \frac{5 N}{8} ) ] + {( - 1 )}^{{k}_{2}} ( {( - j )}^{{k}_{1}} [ x ( {n}_{4} + \frac{3 N}{8} ) + {( - 1 )}^{{k}_{1}} x ( {n}_{4} + \frac{7 N}{8} ) ] ) ) {( - j )}^{{k}_{2}} {W}_{N}^{\frac{N}{8} {k}_{1}} \} \qquad ( 9 )$$

For an N=16 FFT this equation yields the signal flow graph shown in FIG. 8.

Alternately, the recoded butterfly equation Y(k₁,k₂,k₃,n₄) can take the form

$$Y ( {k}_{1} , {k}_{2} , {k}_{3} , {n}_{4} ) = \{ [ x ( {n}_{4} ) + {( - 1 )}^{{k}_{1}} x ( {n}_{4} + \frac{N}{2} ) ] + {( - 1 )}^{{k}_{2}} ( {( - j )}^{{k}_{1}} [ x ( {n}_{4} + \frac{N}{4} ) + {( - 1 )}^{{k}_{1}} x ( {n}_{4} + \frac{3 N}{4} ) ] ) \} + {( - 1 )}^{{k}_{3}} \{ ( ( {W}_{N}^{\frac{N}{8} {k}_{1}} [ x ( {n}_{4} + \frac{N}{8} ) + {( - 1 )}^{{k}_{1}} x ( {n}_{4} + \frac{5 N}{8} ) ] ) + {( - 1 )}^{{k}_{2}} ( {( - j )}^{{k}_{1}} {W}_{N}^{\frac{N}{8} {k}_{1}} [ x ( {n}_{4} + \frac{3 N}{8} ) + {( - 1 )}^{{k}_{1}} x ( {n}_{4} + \frac{7 N}{8} ) ] ) ) {( - j )}^{{k}_{2}} \} \qquad ( 10 )$$

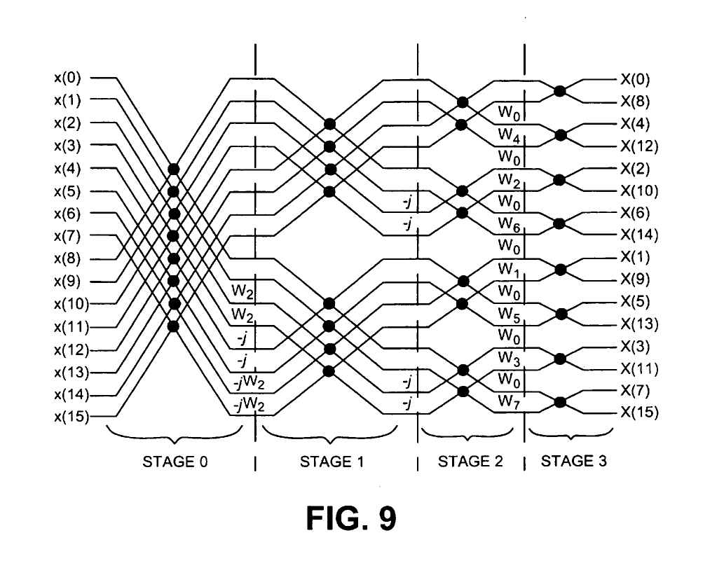

The signal flow graph for an N=16 FFT for this recoding is shown in FIG. 9.

By terminating the twiddle factor decomposition early in power-of-4 or strictly power-of-2 length FFTs and continuing with the standard radix-2 decomposition it is possible to build Fast Fourier Transforms for any power-of-2 length. For noise-related reasons, the decomposition in equation (9) and FIG. 8 is slightly preferable, at present, to the one in equation (10) and FIG. 9 since the butterfly operation with the trivial multiplications appears first followed by the butterfly operation with the multiplication by W_{N}^{N/8}. In implementation for a given noise specification, the standard decomposition allows a second stage memory unit that is smaller than the one obtained using the alternate decomposition would be.

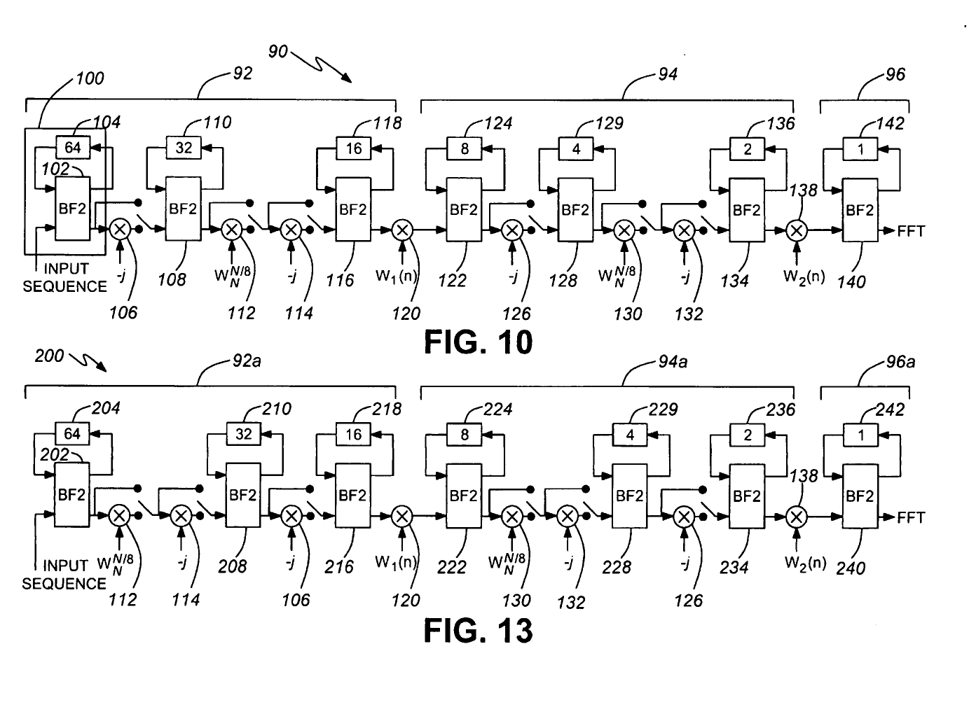

By mapping the recoded twiddle coefficients generated using the method described above into the R2SDF architecture a Recoded Radix-2 Single-path Delay Feedback (RR2SDF) architecture is obtained. FIG. 10 demonstrates an exemplary embodiment of a RR2SDF FFT for N=128.

FIG. 10 illustrates a novel system 90 for implementing an N=128 FFT using RR2SDF. A sequence of samples is provided from an un-illustrated source to a radix-2 butterfly unit (BF2) 102 having a feedback memory 104 for storing 64 samples. One skilled in the art will appreciate that the feedback memory size of 64 samples is selected to hold half of the N=128 samples in the input sequence. Furthermore, the combination of BF2 102 and feedback memory 104 can be referred to as butterfly module 100, as can the combinations of butterfly units and feedback memories described below. The memory 104 receives the output of BF2 102, and provides its contents back to BF2 102 for use in conjunction with a subsequently received sample set. The output of BF2 102 is switched around a multiplier 106 which multiplies the input by a trivial co-efficient −j. This arrangement is referred to as a selectable multiplier. The switching system allows for the selection of multiplication by −j or multiplication by a unity factor, which is implemented as a bypass of the multiplier. One skilled in the art will appreciate that the effect of the multiplication is to simply rotate the output of BF2 102 in the complex plane. The outputs of BF2 102 and multiplier 106 are selectively provided to a second butterfly unit BF2 108. BF2 108 has a similar feedback memory 110 to feedback memory 104 attached to the BF2 102. Feedback memory 110 is preferably sized to hold 32 samples. The output of BF2 108 is switched, and is intermittently provided to multiplier 112 to apply a complex co-efficient of Wₙ^{N/8}. The output of multiplier 112 and the output of BF2 108 are switched as the input to multiplier 114 which applies a factor of −j. This arrangement is a multiply selectable multiplier, where unity, either of the factors, or both of the factors, can be selectively applied to the sequence. The input and output of multiplier 114 are switched as the input to BF2 116 which has a 16 sample feedback memory 118. The selective application of W_{N}^{N/8} and −j serves to perform a phase rotation in the complex plane only where appropriate. BF2 116 has feedback memory 118 sized to store 16 samples. This is the completion of the first triplet 92. The output of BF2 116 is provided to multiplier 120, which multiplies the output by a twiddle factor of W₁(n). The output of BF2 116, after being phase rotated by the twiddle factor is provided as input to BF2 122 which has feedback memory 124 sized to hold 8 samples. The output of BF2 122 is selectively multiplied by multiplier 126, to apply j. The outputs of BF2 122 and multiplier 126 are switched as the input to BF2 128 which has feedback memory 130 preferably sized to hold 4 samples. The multiply selectable multiplier arrangement following BF 108 is similarly applied after BF2 128, where the earlier multiplier 130 applies W_{N}^{N/8} and the second multiplier 132 applies a −j. The input and output of multiplier 132 are selectively switched as the input to BF2 134, which has a feedback memory 136 sized to store 2 samples. The output of BF2 134 is provided to multiplier 138, which applies a twiddle factor of W₂(n). This marks the completion of the second triplet 94. The output of BF2 134, after being phase rotated in multiplier 138 is provided to BF2 140, which has feedback memory 142 sized to store one sample. The output of BF2 140 is the completed FFT of the input sequence. One skilled in the art will appreciate that the above described architecture is described as a pipeline FFT processor having two FFT triplets. The first triplet 92 is the grouping of a first stage BF2 102, a second stage BF2 108 and a third stage BF2 116, along with the corresponding feedback memories and twiddle factor units or multipliers. The second triplet 94 is the grouping of the modules corresponding to BF2 122, BF2 128 and BF2 134, along with the corresponding feedback memories and twiddle factor units or multipliers. The FFT processor is terminated by BF2 140 and its corresponding feedback memory which form an FFT terminator 96. One skilled in the art will appreciate that though there are differences in the feedback memory sizes, the first two triplets are substantially similar.

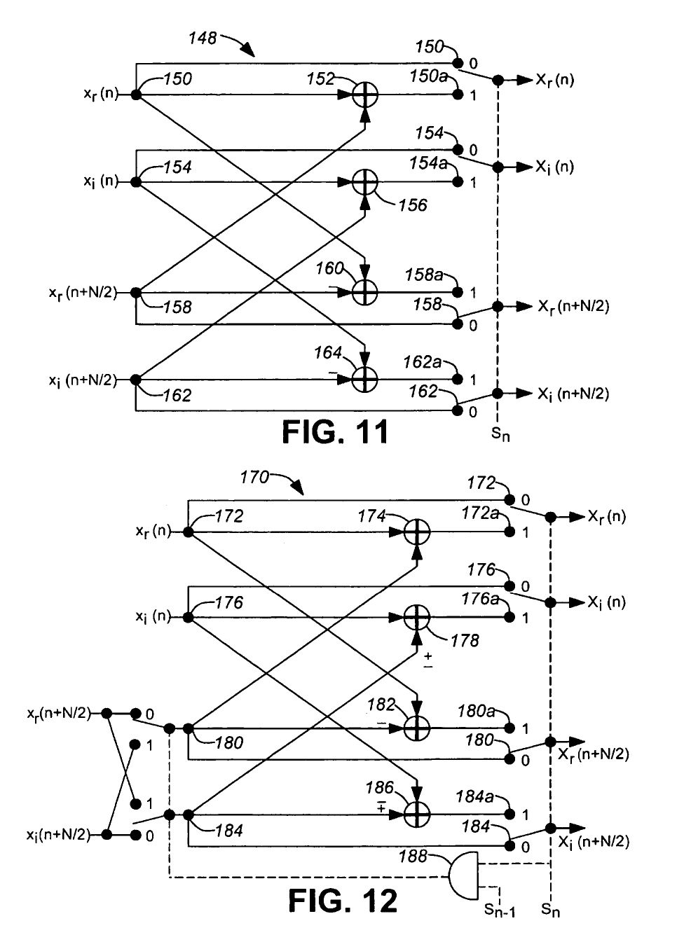

The implementation preferably uses a butterfly unit performing a butterfly operation described by the following equation, which can be implemented using the butterfly unit illustrated in FIG. 11, which is described in detail below.

$$X ( k , n ) = x ( n ) + {( - 1 )}^{k} x ( n + \frac{N}{2} )$$

In the first N/2^{s} cycles, where s is the butterfly stage number beginning at one the butterfly unit, collects data in its feedback memory by bypassing the adder and subtractor hardware. This is achieved by setting the select signal, Sₙ to zero. In the following N/2^{s} cycles the butterfly unit performs a 2-point FFT on the incoming data and the data stored in the feedback registers during the first N/2^{s} cycles. The butterfly unit's first output X(n) is sent to the stage multiplier, which may be followed by a unity multiplier (i.e. a wire), a constant multiplication by W_{N}^{N/8}, or a complex twiddle coefficient multiplier. The choice of multipliers is programmed by process control. The butterfly unit's second output X(n+N/2) is sent back into the feedback memory to be delayed for N/2^{s} cycles. After being delayed, the second output, X(n+N/2), is sent to the stage multiplier. This cycle is repeated until all N data points have been processed. The completed FFT output will leave the final unit in bit-reversed order. Due to the pipelined nature of the FFT processor, multiple FFTs can be performed consecutively without pausing.

FIG. 11 illustrates an exemplary radix-2 butterfly unit 148 through the illustration of its logical layout. The operation of this exemplary butterfly unit 148 corresponds to the method of the butterfly operation described above. One skilled in the art of Very Large-Scale Integration (VLSI) design, Digital Signal Processor (DSP) design, and a plurality of related fields will readily appreciate that this can be implemented using dedicated hardware, programmable gate arrays, or as software implemented on general, or specific, purpose processor chips. The feedback memories of FIG. 10 are employed to allow part of the butterfly operation to be stored for use with subsequent samples. Node 150 receives the real component of the n^{th} sample, xᵣ(n), while node 154 receives xᵣ(n), the imaginary component of the n^{th} sample. Node 158 receives the real component of the (n+N/2)^{th} sample, xᵣ(n+N/2), while node 160 receives xᵢ(n+N/2), the imaginary component of the (n+N/2)^{th} sample. Adder 152 sums the value at nodes 150 and 158, which correspond to the real components of the two samples, and forwards the sum to node 150a. Adder 156 sums the values at nodes 154 and 162, which correspond to the imaginary components of the two samples, and forwards the sum to node 154a. Adder 160 sums the value of node 150 and the negative value of node 158 to obtain the difference in the real values of the two samples. The difference in the real values is forwarded to node 158a. Adder 164 sums the value of node 154 and the negative value of node 162 to obtain the difference in the imaginary values of the two samples. The difference in the imaginary values is forwarded to node 162a. One skilled in the art will appreciate that adders 160 and 164 function as subtractors and can be implemented as such without departing from the present invention. The output of the butterfly unit 148 is controlled by synchronization signal Sₙ, which controls a switch at each output. Xᵣ(n) is determined in accordance with the switching signal, as described above, to select between the values at nodes 150 and 150a. Xᵢ(n) is determined in accordance with the switching signal, as described above, to select between the values at nodes 154 and 154a Xᵣ(n+N/2) is determined in accordance with the switching signal, as described above, to select between the values at nodes 158 and 158a. Xᵢ(n+N/2) is determined in accordance with the switching signal, as described above, to select between the values at nodes 162 and 162a.

The butterfly operation of FIG. 11 can be pre-multiplied by the constant coefficient (−j)^{k} yielding the following equation, for which an exemplary implementation is illustrated in FIG. 12.

$$X ( {k}_{1} , {k}_{2} , n ) = {( - j )}^{{k}_{1}} ( x ( n ) + {( - 1 )}^{{k}_{2}} x ( n + \frac{N}{2} ) )$$

In the butterfly unit, the first N/2^{s} cycles, where s is the butterfly stage number beginning at one, the FFT collects data in the feedback memory by bypassing the butterfly unit adder and subtractor hardware. This is achieved by setting the select signal, Sn on the 2-to-1 output multiplexers to zero. In the following N/2^{s} cycles the butterfly unit performs a 2-point FFT on the incoming data and the data stored in the feedback registers during the first N/2^{s} cycles. For FFT stages that require a pre-multiplication by −j this multiplication is a trivial operation requiring the real and imaginary components of the input signal to be swapped and inversion of the add-subtract sense on the imaginary data path through the butterfly unit. For the first 3N/2^{s}+2 inputs a unity pre-multiplication is performed and for the final N/2^{s}+2 inputs the −j complex multiplication is performed. The butterfly unit's first output X(n) is sent to the stage multiplier, which may be followed by a unity multiplier (i.e. a wire), a constant multiplication by W_{N}^{N/8} or a complex twiddle coefficient multiplier, and which choice is programmed by process control. The butterfly unit's second output X(n+N/2) is sent back into the feedback memory to be delayed for N/2^{s} cycles. After being delayed, the second output, X(n+N/2), is sent to the stage multiplier. The completed FFT output will leave the final unit in bit-reversed order. Due to the pipelined nature of the FFT processor, multiple FFTs can be performed consecutively without pausing.

FIG. 12 illustrates an exemplary pre-multiplication radix-2 butterfly unit 170 through the illustration of its logical layout. The operation of this exemplary pre-multiplication butterfly unit 170 corresponds to the method of the butterfly operation described above. As before, one skilled in the art will understand the implementation of this exemplary butterfly on any number of platforms. Node 172 receives the real component of the n^{th} sample, xᵣ(n), while node 176 receives xᵢ(n), the imaginary component of the n^{th} sample. Nodes 180 and 184 receive the real and imaginary components of the (n+N/2)^{th} sample, xᵣ(n+N/2) and xᵢ(n+N/2), as determined by a control signal. The control signal also determines the application of a real-imaginary swap to the values at those nodes prior to their arrival at an adder. The control signal is provided by a logical AND gate 188 receiving as its input switching signals Sₙ₉₋₁, and Sₙ. Sₙ is also used to switch between values after the adder, as will be described below. Adder 174 sums the value at nodes 172 and 180, and forwards the sum to node 172a. Adder 178 sums the value at nodes 176 with the value at node 184 or the negative of the value at node 184, as determined by the control signal of 188. The sum or difference of the values is forwarded to node 176a. Adder 182 sums the value of node 172 and the negative value of node 180 to obtain the difference in the values at the two nodes. The difference in the values is forwarded to node 180a. Adder 186 sums the value of node 176 with the value of node 184 or the negative of the value at node 184, as determined by the control signal of 188. The sum or difference of the values is forwarded to node 184a. One skilled in the art will appreciate that adder 182 functions as a subtractor and adders 178 and 186 with their respective premultiplication by −j function as adder-subtractor blocks and can be implemented without departing from the present invention. The output of the butterfly unit 170 is controlled by synchronization signal Sₙ which controls a switch at each output. Xᵣ(n) is determined in accordance with the switching signal, as described above, to select between the values at nodes 172 and 172a. Xᵢ(n) is determined in accordance with the switching signal, as described above, to select between the values at nodes 176 and 176a. Xᵣ(n+N/2) is determined in accordance with the switching signal, as described above, to select between the values at nodes 180 and 180a. Xᵢ(n+N/2) is determined in accordance with the switching signal, as described above, to select between the values at nodes 184 and 184a One skilled in the art will appreciate that the pre-multiplication performed by this butterfly unit is selectively applied and allows the integration of a selective trivial multiplication with an adjacent butterfly unit which can offer advantages in terms of implementation size and complexity.

FIG. 13 illustrates a novel system 200 for implementing an FFT using RR2SDF, where N=128. A sequence of samples is provided from an un-illustrated source to a radix-2 butterfly unit (BF2) 202 having a feedback memory 204 for storing 64 samples. The memory receives the output of BF2 20Z and provides its contents back to BF2 202 for use in conjunction with a subsequently received sample set. The output of BF2 202 is provided to a multiply selectable multiplier where it is intermittently provided to multiplier 112 to apply the complex co-efficient E_{N}^{N/8}. The output of multiplier 112 and the output of BF2 202 are switched as the input to multiplier 114, which applies the trivial co-efficient −j. The input and output of multiplier 114 are switched as the input to BF2 208. BF2 208 has a similar feedback memory 210 to feedback memory 204 attached to the BF2 202. Feedback memory 210 is preferably sized to hold 32 samples. The output of BF2 208 is provided to a selectable multiplier, in this embodiment multiplier 106, used to apply −j. The outputs of BF2 208 and multiplier 106 are provided to as input to BF2 216 which has a 16 sample feedback memory 218. The output of BF2 216 is provided to multiplier 120, which multiplies the output by a twiddle factor of W₁(n). The system as described thus far forms the first triplet 92a of the system of FIG. 13. One skilled in the art will appreciate that the architecture of this first triplet 92a is similar in structure to the architecture of the first triplet 92 of the embodiment illustrated in FIG. 10. In the first triplet 92 and 92a of FIGS. 10 and 13 the BF2 units remain similarly arranged, but the application of the twiddle factors is re-ordered, so that the twiddle factor applied between the first two BF2 units in the embodiment of FIG. 10 is applied between the second and third BF2 units in the embodiment of FIG. 13, and visa versa. In the second triplet 94a of the system, the output of multiplier 120 is used as an input to BF2 222 which has feedback memory 224 sized to hold 8 samples. The output of BF2 222 is provided to the multiply selectable multiplier arrangement of multipliers 130 and 132 where the earlier multiplier 130 applies a complex co-efficient of W_{N}^{N/8}, and the second multiplier 132 applies a trivial co-efficient of −j. The input and output of multiplier 132 are switched between as the input to BF2 228, which has a feedback memory 229 sized to store 4 samples. The output of BF2 228 is switched around multiplier 126, which applies a trivial co-efficient of −j. The outputs of BF2 228 and multiplier 126 are switched as the input to BF2 234 which has feedback memory 236 preferably sized to hold 2 samples. The output of BF2 234 is provided to multiplier 138 where it is phase rotated by the twiddle factor W₂(n). This forms the end of the second triplet in the system. The output of multiplier 138 is provided to FFT terminator 96a which includes BF2 240, which has feedback memory 242 sized to store one sample. The output of BF2 240 is the completed FFT of the input sequence.

The implementations described above in reference to FIGS. 10 and 13 employ multipliers, selectable multipliers, and multiply selectable multipliers. A multiplier receives two inputs and provides as an output the product of its inputs. Multipliers are used in the exemplary embodiments of FIGS. 10 and 13 for the application of twiddle factors. Selectable multipliers are the combination of multipliers and switches arranged such that the multiplier can be bypassed. Selectable multipliers are used in the exemplary embodiments of FIGS. 10 and 13 for the application of the trivial co-efficient −j between two butterfly modules and for the application of the complex coefficient W_{N}^{N/8}. Multiply selectable multipliers are arrangements of two, or more, selectable multipliers in series. The arrangement of the selectable multipliers in series allows none, either, or both of the multipliers to be bypassed. Multiply selectable multipliers are used in the exemplary embodiments of FIGS. 10 and 13 for the application of the trivial co-efficient −j the complex co-efficient W_{N}^{N/8}, both −j and W_{N}^{N/8}, or a unity factor. Either the selectable multiplier or the multiply selectable multiplier can be used to selectively apply a unity multiplication by bypassing the multipliers.

Note that the butterfly architecture between the two RR2SDF decompositions is the same, however the placement of the trivial multiplication by W_{N}^{N/8} is different. When attempting to meet a noise specification the memory buffer requirement of the second and fifth buffers will be larger in the alternate RR2SDF decomposition over the standard decomposition previously shown. This is especially significant in the case of the second buffer, which has N14 complex memory storage elements.

A comparison of the number of complex multipliers, adders, and memory units for the previously discussed pipeline processor FFT architectures is shown in Table 1. In this table all values have been listed using the base-4 logarithm where applicable, in order to ease comparisons of radix-2, radix-4, and radix-8 architectures.

TABLE 1
Comparison of the number of complex multipliers,
adders, and memory units for the previously
discussed pipeline processor FFT architectures

| | Multiplier # | Adder # | Memory Size |
|---|---|---|---|
| R2MDC | 2(log₄N − 1) | 4log₄N | 3N/2 − 2 |
| R4MDC | 3(log₄N − 1) | 8log₄N | 5N/2 − 4 |
| R2SDF | 2(log₄N − 1) | 4log₄N | N − 1 |
| R4SDF | log₄N − 1 | 8log₄N | N − 1 |
| R4SDC | log₄N − 1 | 3log₄N | 2N − 2 |
| R2²SDF | log₄N − 1 | 4log₄N | N − 1 |
| R2³SDF | log₄N − 1 | 4log₄N | N − 1 |
| R2SDP | log₄N − 1 | 2log₄N | N − 1 |
| R2SDP (in-order) | log₄N − 1 | 2log₄N | 2N − 2 |
| RR2SDF | log₄N − 1 | 4log₄N | N − 1 |

In Table 1 it appears as though the performance of the RR2SDF architecture is the same as the R2²SDF architecture. In practice however, the RR2SDF architecture typically has only log₈N−1 complex multipliers (requires 4 real multipliers and 2 real adders per complex multiplier) and log₈N−1 constant complex multipliers (requires 2 real constant multipliers and 2 real adders per operation) compared to the log₄N−1 complex multipliers in the conventional R2²SDF architecture. The RR2³SDF and R2³SDF architectures have a comparable number of operators, however unlike the R2³SDF architecture the RR2SDF architecture is not limited to power-of-8 FFT lengths but is capable of all power-of-2 FFT lengths. The R2³SDF architecture requires additional registering stages in the butterfly unit that need not be present in the RR2SDF architecture. The order of the constant multiplication in the standard RR2SDF architecture allows better practical hardware performance for the second stage memory for a given noise performance specification over the alternate RR2SDF or R2³SDF architectures.

FIG. 14 illustrates the triplet of the present invention. Butterfly module 100a includes butterfly unit 248 and feedback memory 250. Memory 250 is preferably sized to hold N/2 samples, where the sequence length to the triplet is N, a power of 2. Butterfly module 100a provides a 2-point FFT output to selectable multiplier 256, which selectively multiplies the 2-point output of 100a by complex co-efficient −j. The output of selectable multiplier 256 is provided to butterfly module 100b, which has butterfly unit 248 and memory 252, which is sized to hold N/4 samples. Butterfly module 100b provides a 2-point FFT output on the sequence of samples provided by selectable multiplier 256. The 2-point FFT output of butterfly module 100b is provided to multiply selectable multiplier 258, which selectively multiplies the output of the butterfly module 100b by W_{N}^{N/8} and/or −j as appropriate. The resulting output of selectable multiplier 258 is provided to butterfly module 100c, which has butterfly unit 248 and a memory 254 sized to hold N/8 samples. The resulting 2-point FFT output is provided to a multiplier which applies the appropriate twiddle factor W₁(n) to the output.

One skilled in the art will appreciate that the triplet of the present invention can be used in series with other triplets to design an FFT processor for any power-of-8 length of input string. The FFT processor of the present invention requires a minimum number of butterfly operations for a sequence of a given length. For an FFT operation on a sequence of length-N there are three different terminating conditions for the FFT that allow for any power-of-2 length FFT to be implemented. These three terminating conditions are related to the length of the input sequence N, and can be quickly determined by evaluation of (log₂N)mod3. When (log₂N)mod3=0 the FFT requires no FFT terminator, as the number of required butterfly operations has been performed by the series of FFT triplets. When (log₂N)mod3=1, the triplets have performed all but one of the required butterfly operations. Thus, when (10g₂ N)mod3=1 the FFT processor requires an FFT terminator having a single terminating butterfly as shown in FIG. 15. The (log₂ N)mod3=1 terminator 260 includes butterfly unit 262 with a memory 260 sized to hold a single sample. When (log₂N)mod3=2, the triplets have performed all but two of the required butterfly operations. Thus, when (log₂N)mod3=2 the FFT requires an FFT terminator as illustrated in FIG. 16. The (log₂N)mod3=2 terminator includes butterfly unit 268 with memory 270 sized to hold 2 samples. The output of butterfly unit 268 is selectively multiplied by multiplier 272 which selectively applies −j. The output of selectable multiplier 272 is provided to butterfly unit 274 which is connected to feedback memory 276 sized to hold 1 sample. Terminators 260 and 266, when placed following an appropriate series of triplets, provide termination to the FFT processor allowing the design of processors for any input sequence length N, where N is a power-of-2.

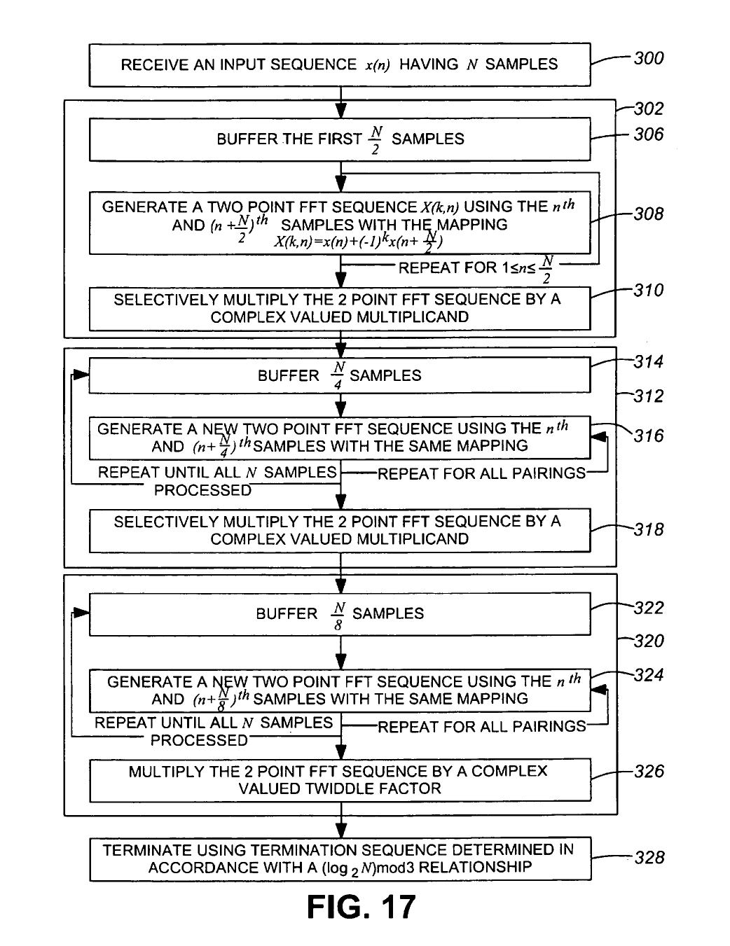

FIG. 17 is a flowchart illustrating a method of the present invention. In step 300 an input sequence of Nsamples is received. Steps 306, 308 and 310 correspond to the operation of the first butterfly module, and form step 302. In Step 306 the first half of the samples are buffered. The buffered samples in conjunction with unbuffered newly arriving samples are used pairwise to generate a 2-point FFT in step 308. The pairwise generation of 2-point FFTs is repeated for each pair. Each of the 2-point FFT sequence is selectively multiplied by a complex valued multiplicand in step 310.

Step 312 corresponds to the operation of the second butterfly module in the triplet. In step 314 one quarter of the samples are buffered. Upon buffering N/4 samples, the buffered and newly arriving samples are used to generate a new pairwise 2-point FFT sequence in step 316. Steps 316 and 314 are repeated until all N samples in the sequence have been appropriately processed. The pairwise FFT sequence of step 316 is selectively multiplied by a complex valued multiplicand in step 318.

Step 320 corresponds to the operation of the third butterfly module in the triplet. In step 322 one eighth of the samples provided by step 318 are buffered. A 2-point FFT is generated on the basis of the buffered samples and newly arriving samples in step 324. The generation of the FFT sequence is continued for all pairings in the memory, and steps 322 and 324 are repeated until all N samples have been processed. The result of step 324 is selectively multiplied by a complex valued twiddle factor in step 326.

In step 328 an appropriate termination sequence, determined in accordance with the [log₂N]mod3 relationship, is then applied to the output of the third butterfly module in the triplet.

The method and system of the present invention allow for a simplified design to be implemented for an FFT processor. The FFT processor of the present invention utilises a repetitive structure, the FFT triplet, along with an easy to determine terminating element, the sequence terminator. The repetitive use of the FFT triplet along with the appropriate terminator allows for the extendability of the FFT processor of the present invention to accommodate an input sequence of any length N, where N=2^{Q}, and Q is a non-negative integer. As noted above the architecture of the present invention provides an implementation no larger than prior art solutions, and at the same time provides applicability to all sequence whose length is a power-of-2, as opposed to a power-of-8 used by the R2³SDF implementation of the prior art.

The above-described embodiments of the present invention are intended to be examples only. Alterations, modifications and variations may be effected to the particular embodiments by those of skill in the art without departing from the scope of the invention, which is defined solely by the claims appended hereto.

1. A pipelined fast Fourier transform (FFT) processor for receiving an input sequence, the processor comprising:
at least one FFT triplet having first, second and third butterfly modules connected in series by selectable multipliers for selectively performing trivial co-efficient multiplication and complex co-efficient multiplication on output sequences of adjacent butterfly modules, each of the at least one FFT triplets terminating in a twiddle factor multiplier for applying a twiddle factor to an output of the third butterfly module of the respective triplet, the at least one FFT triplet for receiving the input sequence and for outputting a final output sequence representing an FFT of the input sequence.

2. The processor of claim 1, wherein each butterfly module includes a radix-2 butterfly unit and a feedback memory.

3. The processor of claim 2, wherein, for an input sequence of N samples, an output sequence X(k, n) of each butterfly module is equal to
$$x ( n ) + {( - 1 )}^{k} x ( n + \frac{N}{2} ) .$$

4. The processor of claim 1, wherein at least one of the selectable multipliers for performing trivial co-efficient multiplication is integrated in an adjacent butterfly module.

5. The processor of claim 1, wherein the selectable multipliers each include a multiplier and a switch for bypassing the multiplier.

6. The processor of claim 1, wherein the first and second butterfly modules are connected by a selectable multiplier for selectively applying trivial co-efficient multiplication.

7. The processor of claim 6, wherein the second and third butterfly modules are connected by a selectable multiplier for performing trivial co-efficient multiplication and a selectable multiplier for performing the complex co-efficient multiplication W_{N}^{N/8}.

8. The processor of claim 2, wherein, for an input sequence having N samples, the feedback memories for the first, second and third butterfly modules hold N2, N/4 and N/8 samples, respectively.

9. The processor of claim 1 wherein the input sequence is of length N, where (log₂N)mod3=1, the processor having a plurality of FFT triplets in seriatim and further including an FFT terminator having a butterfly unit and a corresponding memory sized to hold a single sample, the FFT terminator for receiving the output sequence from the final twiddle factor multiplier and for performing a butterfly operation on the received output sequence to render an FFT of the input sequence.

10. The processor of claim 1 wherein the input sequence is of length N, where (log₂N)mod3=2, the processor having a plurality of FFT triplets in seriatim and further including an FFT terminator having first and second butterfly units having corresponding memories sized to hold two samples and a single sample respectively, the first butterfly unit connected to the second butterfly unit by a selectable multiplier for selectively multiplying the output of the first butterfly unit by −j, the FFT terminator for receiving the output sequence from the final twiddle factor multiplier and for performing a pair of butterfly operations on the received output sequence to render an FFT of the input sequence.

11. The processor of claim 1, wherein the twiddle factor multiplier is a cordic rotator.

12. A pipelined fast Fourier transform (FFT) processor for receiving an input sequence of N samples, the processor comprising:
at least one FFT triplet, the triplet having:
a first FFT stage having a first stage radix-2 butterfly unit for receiving the input sequence and for providing a first stage output sequence in accordance with a butterfly operation performed on the input sequence, the first stage radix-2 butterfly unit having a first feedback memory connected thereto;
a second FFT stage having a selectable multiplier for selectively multiplying the first stage output sequence by a trivial co-efficient, and a second stage radix-2 butterfly unit for providing a second stage output sequence in accordance with the butterfly operation performed on the output of the selectable multiplier, the second stage radix-2 butterfly unit having a second feedback memory connected thereto; and
a third FFT stage having a multiply selectable multiplier for selectively multiplying the second stage output sequence by at least one of the trivial co-efficient and a complex co-efficient, a third stage radix-2 butterfly unit for providing a butterfly output in accordance with the butterfly operation performed on the output of the multiply selectable multiplier, the third stage radix-2 butterfly unit having a third feedback memory connected thereto, and a multiplier for multiplying the butterfly output by a twiddle factor, to provide an output sequence corresponding to an FFT of the input sequence.

13. The FFT processor of claim 12, wherein each of the first, second and third stage output sequences X(k,n) is equal to
$$x ( n ) + {( - 1 )}^{k} x ( n + \frac{N}{2} ) .$$

14. The FFT processor of claim 12, wherein at least one of the butterfly units includes an integrated pre-multiplication function for applying a trivial co-efficient multiplication to a received input sequence.
The FFT processor of claim 12, further including an FFT terminator determined in accordance with the length N of the input sequence.

15. A pipelined fast Fourier transform (FFT) processor for receiving an input sequence of N samples, the processor comprising:
at least one FFT triplet, the triplet having:
a first FFT stage having a first stage radix-2 butterfly unit for receiving the input sequence and for providing a first stage output sequence in accordance with a butterfly operation performed on the input sequence, the first stage radix-2 butterfly unit having a first feedback memory connected thereto;
a second FFT stage having a multiply selectable multiplier for selectively multiplying the first stage output sequence by at least one of the trivial co-efficient and a constant complex co-efficient, and a second stage radix-2 butterfly unit for providing a second stage output sequence in accordance with the butterfly operation performed on the output of the selectable multiplier, the second stage radix-2 butterfly unit having a second feedback memory connected thereto; and
a third FFT stage having a selectable multiplier for selectively mUltiplying the second stage output sequence by a trivial co-efficient, a third stage radix-2 butterfly unit for providing a butterfly output in accordance with the butterfly operation performed on the output of the selectable multiplier, the third stage radix-2 butterfly unit having a third feedback memory connected thereto, and a multiplier for multiplying the butterfly output by a twiddle factor, to provide an output sequence corresponding to an FFT of the input sequence.

16. The FFT processor of claim 15, wherein each of the first, second and third stage output sequences X(k,n) is equal to
$$x ( n ) + {( - 1 )}^{k} x ( n + \frac{N}{2} ) .$$

17. The FFT processor of claim 15, wherein at least one of the butterfly units includes an integrated pre-multiplication function for applying a trivial co-efficient multiplication to a received input sequence.

18. The FFT processor of claim 15, further including an FFT terminator determined in accordance with the length N of the input sequence.

19. The FFT processor of claim 18, wherein the FFT terminator includes a butterfly module having a memory sized to store a single sample, for receiving as a terminator input, the output of the third FFT stage multiplier and for performing a butterfly operation on the terminator input to render an FFT of the input sequence of N samples.

20. The FFT processor of claim 18, wherein the FFT terminator includes a first butterfly module having a memory sized to store a pair of samples, for receiving as a terminator input, the output of the third stage multiplier and for performing a butterfly operation on the terminator input, and a second butterfly module connected to the first butterfly module of the terminator by a selectable multiplier, the selectable multiplier for selectively multiplying the output of the first butterfly module of the terminator by −j, the second butterfly module having a memory sized to store a single sample and for performing a butterfly operation on the selectively multiplied output of the first butterfly module of the terminator to render an FFT of the output sequence.

21. A method of performing an FFT on a sequence of N samples in an FFT processor having a butterfly module, the method comprising:
for all integers 1≦x≦log₂N, repeating the steps of receiving and buffering
$$\frac{N}{{2}^{x}}$$
samples at a time from a sequence having N samples;
generating a 2-point FFT using the n^{th} and the
$${( n + \frac{N}{{2}^{x}} )}^{th}$$
samples;
selectively multiplying the generated 2-point FFT sequence by a complex valued multiplicand;
terminating the FFT using a termination sequence determined in accordance with a (log₂N)mod3 relationship.

22. The method of claim 21 wherein the complex valued multiplicand is selected from a list including 1,
$$- j , \frac{\sqrt{2}}{2} - j \frac{\sqrt{2}}{2} ,$$
and a complex twiddle factor co-efficient.

23. The method of claim 21 wherein (log₂N)mod3=1 and the step of terminating the FFT includes buffering a sample received from the final selective multiplication and performing a 2-point FFT using the buffered sample and the subsequent sample in the sequence to obtain the FFT of the sequence of N samples.

24. The method of claim 21 wherein (log₂N)mod3=2 and the step of terminating the FFT includes:
buffering a pair of samples received from the final selective multiplication and performing pair-wise 2-point FFTs using the two buffered samples and the two subsequent samples in the sequence;
selectively multiplying the result of the pair-wise 2 point FFT by −j; and
buffering a sample received from the selective multiplication of the pair-wise 2-point FFT and performing a 2-point FFT using the buffered sample and the subsequent sample in the sequence to obtain the FFT of the sequence of N samples.
